(19) United States
(12) Patent Application Publication
(10) Pub. No.: US 2007/0268436 A1
(43) Pub. Date: Nov. 22, 2007

(54) LIQUID CRYSTAL DISPLAY APPARATUS

(76) Inventors: Jin-Yun KIM, Chungcheongnam-do (KR); Kyoung-Jun Jang, Chungcheongnam-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/697,995

(22) Filed: Apr. 9, 2007

(30) Foreign Application Priority Data
May 22, 2006 (KR) 2006-039654

(51) Int. Cl. G02F 1/1337

(52) U.S. Cl. 349/129

(57) ABSTRACT

A liquid crystal display apparatus includes a first substrate on which a pixel area is defined, a second substrate facing the first substrate, and liquid crystals interposed between the first and second substrates. The pixel area is divided into a plurality of domains according to the alignment direction of the liquid crystals. The domains compensate for optical characteristics, thereby widening the viewing angle of the liquid crystal display apparatus. The liquid crystals include smectic liquid crystals that form a layered structure in a specific direction. When the liquid crystal display apparatus is driven, the smectic liquid crystals rapidly respond to the electric field, thereby improving the operational speed of the liquid crystal apparatus.

### CROSS-REFERENCE TO RELATED APPLICATION

This application relies for priority upon Korean Patent Application No. 2006-39654 filed on May 2, 2006 in the Korean Intellectual Property Office, the contents of which are herein incorporated by reference.

1. Field of the Invention

The present invention relates to a display apparatus and, more particularly, to a liquid crystal display apparatus using a liquid crystal.

2. Description of the Related Art

A liquid crystal display apparatus uses liquid crystals having the mesomorphic phase which exhibits both liquid and crystal properties. In a liquid crystal display apparatus the liquid crystals are aligned between two substrates. Since the liquid crystals have dielectric anisotropy and refractive index anisotropy, the alignment of the liquid crystals is changed when an electric field is applied to the liquid crystals and the light transmittance of the liquid crystal display apparatus varies according to the alignment state of the liquid crystals which is determined by an applied electric field corresponding to display information. The time it takes for the applied electric field to align the liquid crystals determines the operational speed of the liquid crystal display apparatus. Recently, attempts have been made to improve the operational speed of the liquid crystal display apparatus.

The term “viewing angle” refers to the angle within which a user can properly view a displayed image. Liquid crystal display apparatus generally have a narrow viewing angle due to the refractive index anisotropy of the liquid crystals. That is, the image displayed in the LCD device is seen as a distorted image when a person views the image from a lateral side of the LCD apparatus. It would be extremely advantageous to provide a liquid crystal display apparatus having better operational speed and a wider viewing angle.

### SUMMARY OF THE INVENTION

In one aspect of the present invention, a liquid crystal display apparatus is provided with a pixel electrode that is formed on the pixel area of a first substrate and includes a first domain divider. A common electrode is formed on a second substrate facing the pixel electrode and is provided with a second domain divider which interacts with the first domain divider to divide the pixel area into a plurality of domains. The liquid crystals include smectic liquid crystals that form a layered structure in a specific direction.

The smectic liquid crystals have achiral and anti-ferroelectric properties. In this case, the liquid crystals are aligned substantially vertically to a predetermined direction of the layered structure or inclined with respect to a predetermined direction of the layered structure.

The liquid crystal display apparatus further includes a vertical alignment layer, which is formed on the pixel electrode and the common electrode, to align the liquid crystals vertically to the first and second substrates. Voltages are applied to the pixel electrode and the common electrode such that an electric field is applied to the liquid crystals, in which the liquid crystals represent an intermediate gray scale when the electric field is within a range of about 2 V/μm to about 3.5V/μm. In this case, liquid crystals may have a negative dielectric anisotropy.

The first and second domain dividers include cut-out sections obtained by cutting predetermined portions of the pixel electrode and the common electrode, or protrusions protruding from a predetermined portion of the pixel electrode or the common electrode.

A gate line and a data line are formed on the first substrate while crossing each other in order to define the pixel area on the first substrate.

The gate line extends in a first direction and the data line extends in a second direction substantially perpendicular to the first direction. In this case, the first and second domain dividers are tilted with respect to the first and second directions. In addition, the first and second domain dividers can include parts which are substantially parallel to at least one of the first and second directions.

The gate line extends in a first direction and the data line consecutively extends in second and third directions, which are bent symmetrical to each other about the first direction. In this case, the first and second domain dividers are formed in substantially parallel to the second and third directions.

### BRIEF DESCRIPTION OF THE DRAWINGS

The above and other objects, features and advantages of the present invention will become readily apparent by reference to the following detailed description when considered in conjunction with the accompanying drawings, in which:

FIG. 1 is a plan view illustrating a liquid crystal display apparatus according to an exemplary embodiment of the present invention;

FIGS. 2A and 2B are views illustrating the alignment state of liquid crystals used in the liquid crystal display apparatus shown in FIG. 1;

FIGS. 3A and 3B are sectional views illustrating the operational state of the liquid crystal display apparatus according to the exemplary embodiment of the present invention;

FIGS. 4A and 4B are cross-sectional views illustrating the operational state of the liquid crystal display apparatus according to another exemplary embodiment of the present invention;

FIGS. 5A to 5C are graphs showing light transmittance as a function of voltages;

FIG. 6 is a graph showing light transmittance as a function of an electric field applied to liquid crystals;

FIG. 7 is a graph showing the contrast ratio of the liquid crystal display apparatus measured from various measurement positions;

FIG. 8 is a plan view illustrating a liquid crystal display apparatus according to another exemplary embodiment of the present invention;

FIG. 9 is a cross-sectional view taken along line II-II′ shown in FIG. 8;

FIG. 10 is a plan view illustrating a liquid crystal display apparatus according to still another exemplary embodiment of the present invention; and

FIG. 11 is a cross-sectional view taken along a line III-III′ shown in FIG. 10.

### DESCRIPTION OF THE EMBODIMENTS

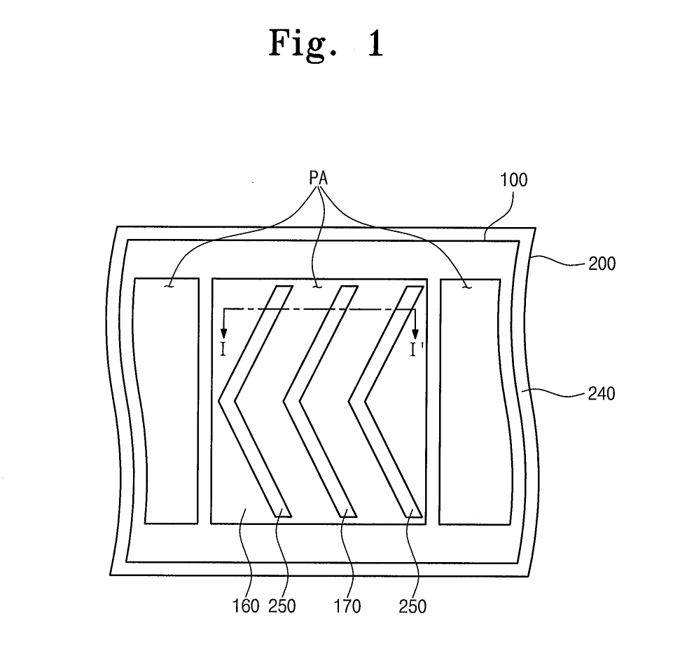

FIG. 1 is a plan view illustrating a liquid crystal display apparatus according to an exemplary embodiment of the present invention.

Referring to FIG. 1, the liquid crystal display apparatus includes a first substrate 100 and a second substrate 200. Pixel areas PA are defined on the first substrate 100.

A liquid crystal layer (not shown) is interposed between the first and second substrates 100 and 200. The pixel area PA is divided into a plurality of domains according to the alignment of liquid crystals. A pixel electrode 160 and a common electrode 240 are formed on the first and second substrates 100 and 200, respectively. First and second domain dividers 170 and 250 are provided in pixel electrode 160 and common electrode 240, respectively. The first and second domain dividers 170 and 250 may interact with each other such that each of the pixel areas PA can be divided into a plurality of domains.

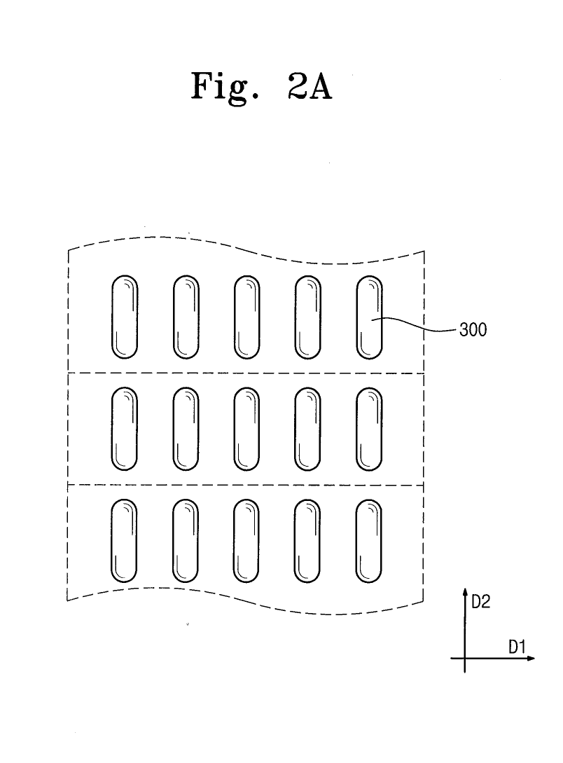

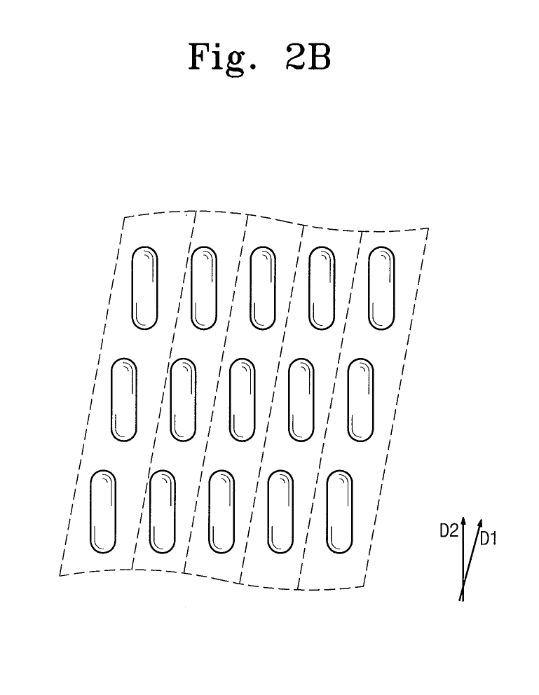

FIGS. 2A and 2B are views illustrating the alignment state of liquid crystals used in the liquid crystal display apparatus shown in FIG. 1.

Referring to FIGS. 2A and 2B, liquid crystals 300 are aligned in a first direction D₁ while forming liquid crystal layers. In addition, liquid crystals 300 are also aligned in a second direction D₂ that is different from the first direction D₁. Such an alignment direction D₂ of liquid crystals 300 is identical to a long-axis direction of the liquid crystals having an oval shape. In this manner, liquid crystals 300 have positional order while forming the liquid crystal layers in the first direction D₁. In addition, liquid crystals 300 have orientational order in the second direction D₂. Liquid crystals 300 aligned in the same layer interact with each other, so that the molecular movement of liquid crystals 300 is restricted. In contrast, liquid crystals 300 aligned in different layers are subject to relatively weak interaction, so that the liquid crystal molecules may slidably move between the liquid crystal layers.

Liquid crystals 300 having positional and orientational orders include smectic liquid crystals. The smectic liquid crystals are classified into various types according to the three-dimensional order thereof. Up to now, smectic A to K liquid crystals have been found, so that various types of the smectic liquid crystals can be used for the present invention. For instance, smectic A liquid crystals, in which the first direction D₁ is substantially perpendicular to the second direction D₂ as shown in FIG. 2A, or smectic C liquid crystals, in which the first direction D₁ is inclined with respect to the second direction D₂ as shown in FIG. 2B, can be used for the present invention.

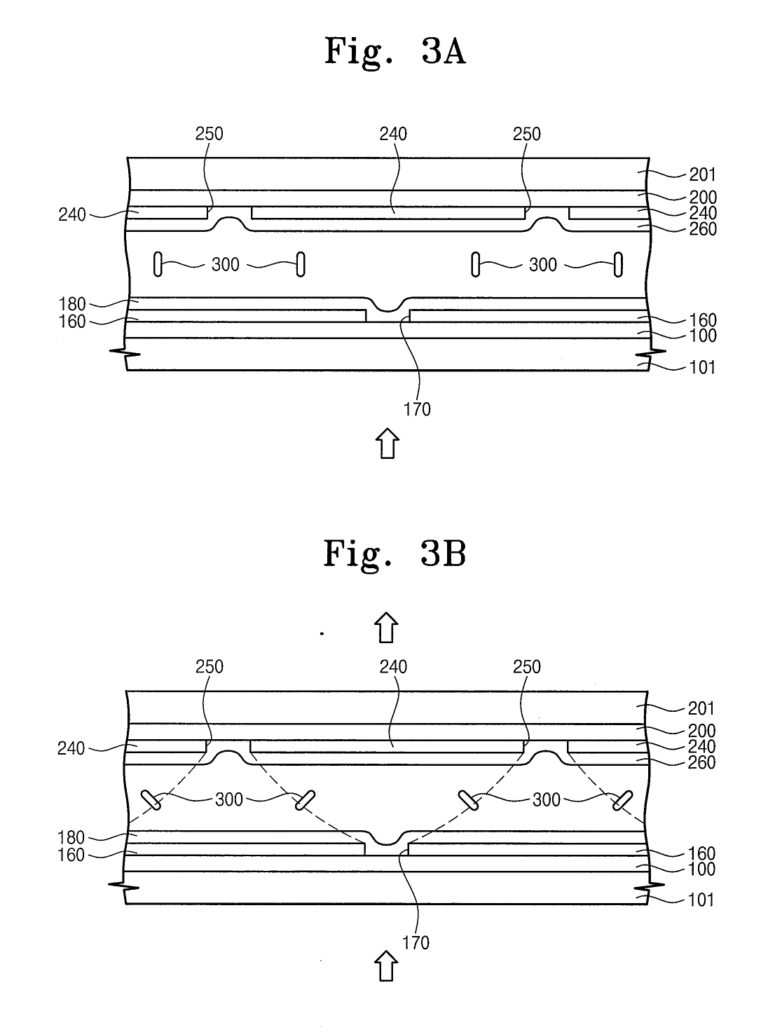

FIGS. 3A and 3B are cross-sectional views illustrating the operational state of the liquid crystal display apparatus according to the exemplary embodiment of the present invention. FIGS. 3A and 3B are taken along a line I-I′ shown in FIG. 1.

Referring to FIG. 3A, first and second polarizing plates 101 and 201 are attached to outer portions of the first and second substrates 100 and 200 that face each other. Pixel electrode 160 and common electrode 240 are provided at inner portions of the first and second substrates 100 and 200, respectively. Pixel electrode 160 is provided with the first domain divider 170, which is a cut-out section obtained by cutting a predetermined portion of pixel electrode 160. Common electrode 240 is provided with the second domain divider 250, which is a cut-out section obtained by cutting a predetermined portion of common electrode 240. The first and second domain dividers 170 and 250 are vertically offset from each other such that the first domain divider 170 does not overlap the second divider 250.

First and second alignment layers 180 and 260 are formed on pixel electrode 160 and common electrode 240, respectively. The first and second alignment layers 180 and 260 may include polyimide-based organic layers or inorganic layers including silicon or silicon oxide. The first and second alignment layers 180 and 260 align liquid crystals 300 in a direction vertical to the first and second substrates 100 and 200. Liquid crystals 300 include smectic liquid crystals which can be aligned while forming liquid crystal layers with respect to the first and second substrates 100 and 200.

During the operation of the liquid crystal display apparatus, light is provided from a lower portion of the first substrate 100 as indicated by an arrow in FIG. 3A. The light is linearly polarized in parallel to a transmission axis of the first polarizing plate 101 while passing through the first polarizing plate 101. The linearly polarized light reaches the second polarizing plate 201 by way of the first substrate 100, liquid crystals 300, and the second substrate 200. If the linearly polarized light passes through liquid crystals 300 in a state in which liquid crystals 300 are aligned vertically to the first and second substrates 100 and 200, a phase variation of the light does not occur. The second polarizing plate 201 is aligned vertically to the transmission axis of the first polarizing plate 101, so that the linearly polarized light that reaches the second polarizing plate 201 is completely absorbed. In this case, the image is not displayed, and the liquid crystal display apparatus exhibits the black state.

Referring to FIG. 3B, different voltages are applied to common electrode 240 and pixel electrode 160, respectively. A constant common voltage is applied to common electrode 240 and a data voltage corresponding to the image to be displayed is applied to pixel electrode 160. At this time, an electric field is formed between common electrode 240 and pixel electrode 160 due to the potential difference between the common voltage and the data voltage, thereby applying the electric field to liquid crystals 300. Although the electric field is formed in the direction vertical to common electrode 240 and pixel electrode 160 which faces the common electrode, the direction of the electric field is changed in the areas where the first and second domain dividers 170 and 250 are formed because the voltage is not applied to the first and second domain dividers 170 and 250.

Accordingly, the electric field is formed along a curved line (shown in a dotted line) from a predetermined area of pixel electrode 160, which is adjacent to the first domain divider 170, to a predetermined portion of common electrode 240, which is adjacent to the second domain divider 250. Thus, the alignment of liquid crystals 300 is changed according to the electric field due to the dielectric anisotropy of liquid crystals 300. Liquid crystals 300 have a negative dielectric anisotropy, so that liquid crystals 300 are aligned while being tilted vertically to the direction of the electrical field. If the alignment of liquid crystals 300 is changed due to the electric field, the phase of the light that has been linearly polarized while passing through the first polarizing plate 101 may be changed as the light passes through liquid crystals 300. Accordingly, the phase-changed light may pass through the second polarizing plate 201 having the transmission axis vertical to the first polarizing plate 101, so that the image may be displayed. When the electric field is maximized, the liquid crystal display apparatus exhibits a maximal white state.

As shown in FIG. 3B, the direction of the electric field is changed at both sides of the first and second domain dividers 170 and 250. As a result, the alignment of liquid crystals 300 is discontinuously changed about the first and second domain dividers 170 and 250, so that the alignment direction of liquid crystals 300 is changed. That is, both sides of the first and second domain dividers 170 and 250 are distinguished from each other. The term “domain” signifies a single area where the alignment of liquid crystals 300 is continuously changed when the electric field is applied thereto, and the pixel area is divided into a plurality of domains due to the interaction between the first and second domain dividers 170 and 250.

In adjacent domains, liquid crystals 300 are aligned in different directions. Thus, the optical characteristics of the adjacent domains are compensated for each other, so that the viewing angle of the liquid crystal display apparatus can be improved. A compensation film can be provided between the first substrate 100 and the first polarizing plate 101 and/or between the second substrate 200 and the second polarizing plate 101. Such a compensation film can further widen the viewing angle of the liquid crystal display apparatus.

In the liquid crystal display apparatus, force is applied to liquid crystals 300 according to the electric field and the interaction among the liquid crystal molecules. Liquid crystals 300 can be maintained in a predetermined alignment state due to the interaction among the liquid crystal molecules. Accordingly, when the electric field is applied to liquid crystals 300, the interaction among the liquid crystal molecules may interfere with the electric field.

As mentioned above, liquid crystals 300 are aligned in a layered structure and the liquid crystal molecules are subject to relatively weak interaction when the liquid crystal molecules are aligned in different layers. Thus, the alignment direction of liquid crystals 300 can be changed within a relatively short period of time when the electric field is applied to liquid crystals 300, so that the operational speed of the liquid crystal display apparatus is improved.

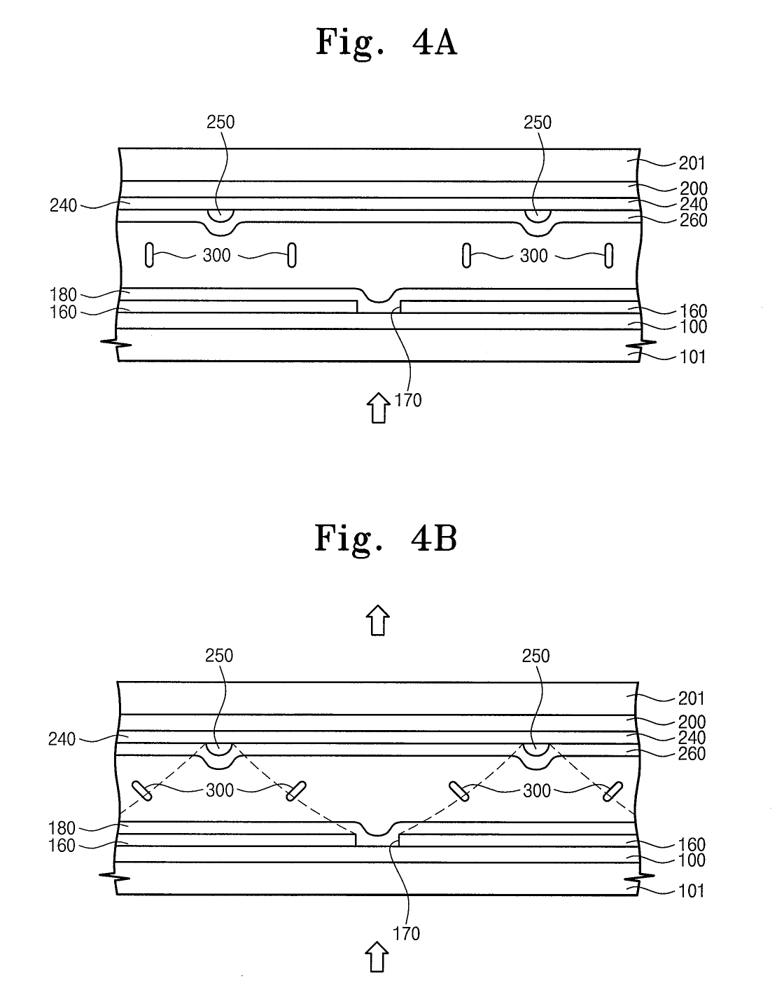

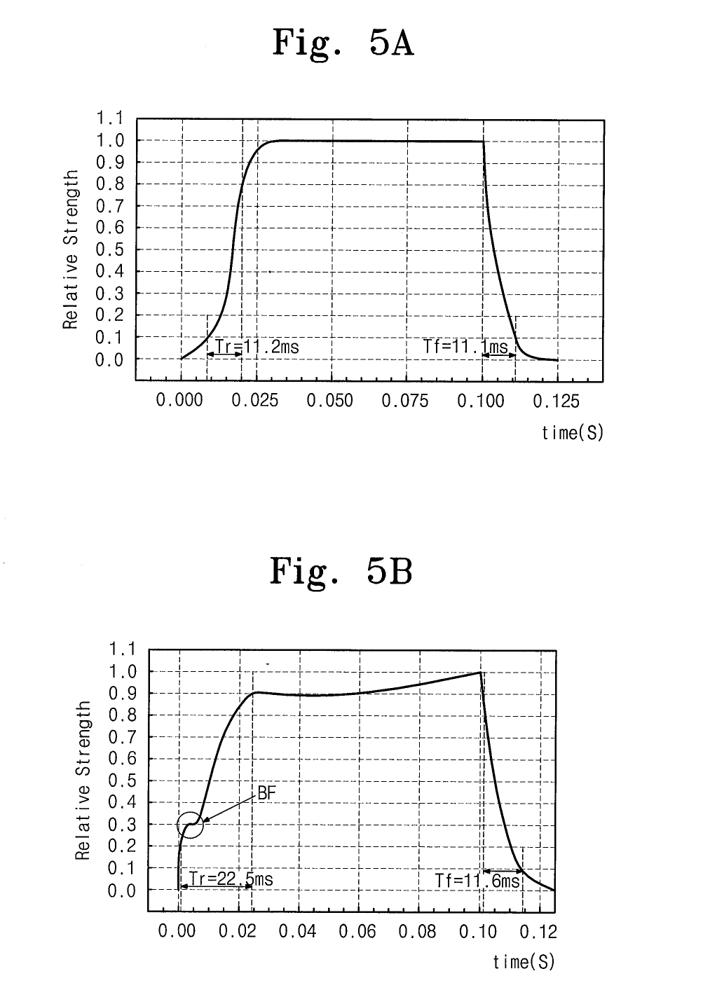

FIGS. 4A and 4B are cross-sectional views illustrating the operational state of the liquid crystal display apparatus according to another exemplary embodiment of the present invention. FIGS. 4A and 4B are taken along a line I-I′ shown in FIG. 1. In the following description, details of parts identical to those of the previous embodiment will be omitted in order to avoid redundancy.

Referring to FIG. 4A, the liquid crystal display apparatus includes first and second substrates 100 and 200, first and second polarizing plates 101 and 201 attached to outer portions of the first and second substrates 100 and 200, respectively, pixel and common electrodes 160 and 240 attached to inner portions of the first and second substrates 100 and 200, respectively, and alignment layers 180 and 260 provided between the pixel and common electrodes 160 and 240. Liquid crystals 300 are aligned between the first and second substrates 100 and 200. Liquid crystals 300 include smectic liquid crystals.

Pixel electrode 160 is provided with a first domain divider 170, which is a cut-out section obtained by cutting a predetermined area of pixel electrode 160. In addition, common electrode 240 is provided with a second domain divider 250, which is a protrusion protruding from common electrode 240 such that the protrusion does not overlap with the cut-out section in the longitudinal direction.

The protrusion is an insulating member, so that the direction of the electric field is changed in the vicinity of the protrusion. The protrusion has a function identical to that of the cut-out section, and the alignment of liquid crystals 300 is changed about the protrusion so that the domains are distinguished from each other.

Pixel electrode 160 may include a protrusion instead of the cut-out section. In this case, although the cut-out section can be formed simultaneously with pixel electrode 160 through the patterning process, an additional process is necessary to form the protrusion in pixel electrode 160. Thus, the manufacturing steps can be reduced when the cut-out section, rather than the protrusion, is formed in pixel electrode 160.

Referring to FIG. 4B, when the data voltage and common voltage are applied to pixel electrode 160 and common electrode 240, respectively, the alignment of liquid crystals 300 is changed. Thus, the phase of the light that has been linearly polarized while passing through the first polarizing plate 101 is changed. Accordingly, the phase-changed light may pass through the second polarizing plate 201, so that the image is displayed. In addition, pixel area PA is divided into a plurality of domains due to the interaction between the protrusion and the cut-out section, so that the optical characteristic of each domain can be improved, thereby widening the viewing angle of the liquid crystal display apparatus.

FIGS. 5A to 5C are graphs showing light transmittance as a function of voltages.

The graphs shown in FIGS. 5A and 5B are obtained from the conventional liquid crystal display apparatus, and the graph shown in FIG. 5C is obtained from the liquid crystal display apparatus according to the exemplary embodiment of the present invention. The liquid crystal display apparatus according to the exemplary embodiment of the present invention includes the common electrode and the pixel electrode, which are provided with the domain dividers and uses smectic C liquid crystals. The conventional liquid crystal display apparatus is provided with the domain divider and uses nematic liquid crystals that are different from the smectic liquid crystals.

In the graphs shown in FIGS. 5A to 5C, the y-axis represents relative strength, that is, the light transmittance, in which “0.0” corresponds to the black state and “1.0” corresponds to the white state. In addition, the x-axis represents time between the black state and the white state, in which “Tr” denotes a rise time needed to change the alignment of the liquid crystals into the white state when the electric field is applied to the liquid crystals, and “Tf” denotes a fall time needed to change the alignment of the liquid crystals from the white state into the black state.

Referring to FIG. 5A, when the liquid crystal display apparatus is driven such that the voltage difference between the pixel electrode and the common electrode is 5.0V in the white state, the Tr and Tf of the nematic liquid crystals are 11.2 ms and 11.1 ms, respectively.

Referring to FIG. 5B, when the liquid crystal display apparatus is driven such that the voltage difference between the pixel electrode and the common electrode is 9.6V, the Tr and Tf of the nematic liquid crystals are 22.5 ms and 11.6 ms, respectively. As the voltage difference increases, the Tr also increases. Especially, different from FIG. 5A, FIG. 5B shows back flow under the high voltage. That is, at a predetermined point of time, the alignment of the liquid crystals is not changed even if the time has lapsed, so that the light transmittance is not increased. This is because the interaction between the liquid crystal molecules interferes with the electric field applied to the liquid crystals.

The nematic liquid crystals are aligned in a specific direction with a predetermined orientational order, but the nematic liquid crystals do not form the layered structure so that the nematic liquid crystals have no positional order. Since the nematic liquid crystals have no layered structure, the interaction between the nematic liquid crystal molecules is greater than the interaction between the smectic liquid crystal molecules, causing the back flow phenomenon BF.

Referring to FIG. 5C, when the liquid crystal display apparatus is driven such that the voltage difference between the pixel electrode and the common electrode is 13.8V, the Tr and Tf of the smectic liquid crystals are 23.2 ms and 18.2 ms, respectively. FIG. 5C exhibits an increase of the Tr and Tf, which is smaller than that of FIG. 5B, although the voltage difference is significantly increased. In addition, the back flow phenomenon does not occur.

The above test results show that the liquid crystal display apparatus using smectic liquid crystals according to the present invention can improve the operational speed of the display as compared with the conventional liquid crystal display apparatus using nematic liquid crystals.

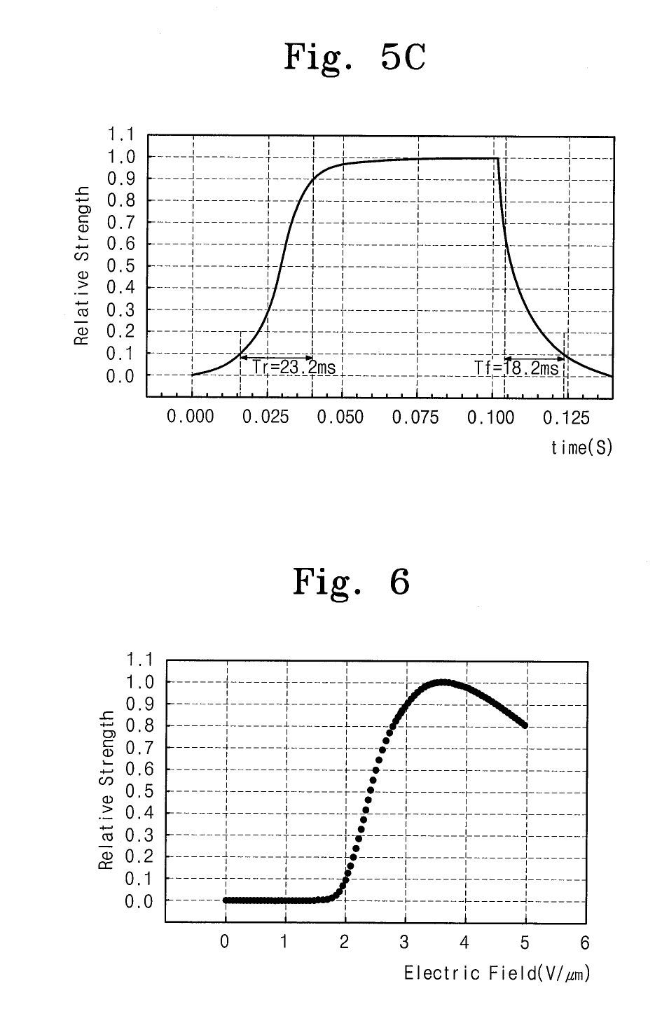

FIG. 6 is a graph showing light transmittance as a function of an electric field applied to liquid crystals. The graph shown in FIG. 6 is obtained from the liquid crystal display apparatus of the present invention, in which the liquid crystal display apparatus includes common and pixel electrodes provided with domain dividers and uses smectic C liquid crystals having achiral and anti-ferroelectric properties.

In the graph shown in FIG. 6, the y-axis represents relative strength, that is, the light transmittance, and the x-axis represents the electric field.

Referring to FIG. 6, when the electric field is changed within the range of zero to about 5V/μm, the liquid crystal display apparatus is changed between the black state (light transmittance 0.0) and the white state (light transmittance 1.0) according to the light transmittance of the liquid crystal display apparatus. In addition, when the electric field is within the range of about 2 V/μm to about 3.5V/μm, the liquid crystal display apparatus exhibits the light transmittance having the median value between the black state and the white state. Accordingly, the liquid crystal display apparatus using the smectic liquid crystals can express the intermediate gray scale in addition to the black state and the white state.

The alignment direction of the liquid crystals is not fixed in one direction of a space, but rotated over the predetermined area of the space. Such a property of the liquid crystal is referred to as “chirality”. The smectic liquid crystals are classified into chiral smectic liquid crystals and achiral smectic liquid crystals based on the chirality thereof. The chiral smectic liquid crystals include the permanent dipole so that the chiral smectic liquid crystals have ferroelectric properties. Due to the ferroelectric properties, the liquid crystals can rapidly respond to the electric field so that the operational speed of the liquid crystal display apparatus can be improved. However, the liquid crystals having the ferroelectric properties exhibit both the white state and the black state, without exhibiting the intermediate gray scale. Thus, the smectic liquid crystals having achiral and anti-ferroelectric properties are preferably used when various color images are displayed by using continuous intermediate gray scale.

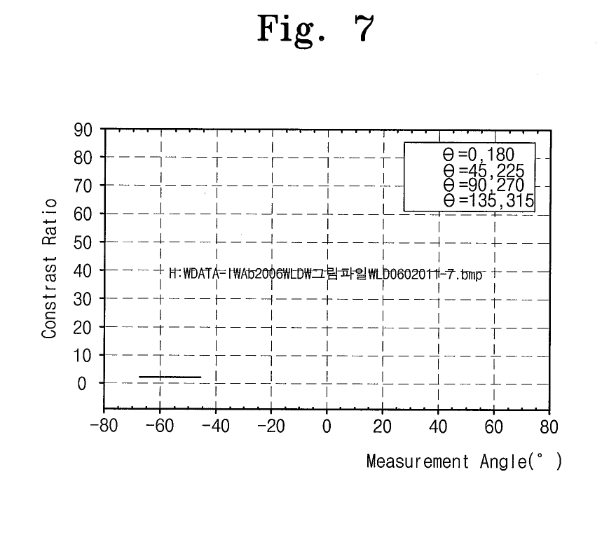

FIG. 7 is a graph showing the contrast ratio of the liquid crystal display apparatus measured from various measurement positions.

The graph shown in FIG. 7 is obtained from the liquid crystal display apparatus of the present invention, in which the liquid crystal display apparatus includes common and pixel electrodes provided with domain dividers and uses smectic C liquid crystals.

In the graph shown in FIG. 7, the y-axis represents the contrast ratio, that is the brightness ratio between the black state and the white state, and the x-axis represents the measurement angles relative to the liquid crystal display apparatus. The brightness is measured from various positions while moving a brightness sensor from a front direction (measurement angle 0° ) of the liquid crystal display apparatus, which is substantially perpendicular to a front surface of the liquid crystal display apparatus, to a lateral direction of the liquid crystal display apparatus, which is tilted from the front direction of the liquid crystal display apparatus. The measurement angle increases proportional to the tilt angle relative to the front direction of the liquid crystal display apparatus. In addition, the contrast ratio has been measured in the front and lateral directions while varying the measurement angles (θ=45θ, 90° and 135° ) on the basis of a reference line (θ=0°).

Referring to FIG. 7, the contrast ratio is symmetrically represented about the front direction of the liquid crystal display apparatus regardless of the measurement angles (θ=45°, 90° and 135°). Therefore, the liquid crystal display apparatus according to the exemplary embodiment of the present invention does not cause asymmetrical brightness and has uniform optical viewing angle characteristics in left and right sides thereof.

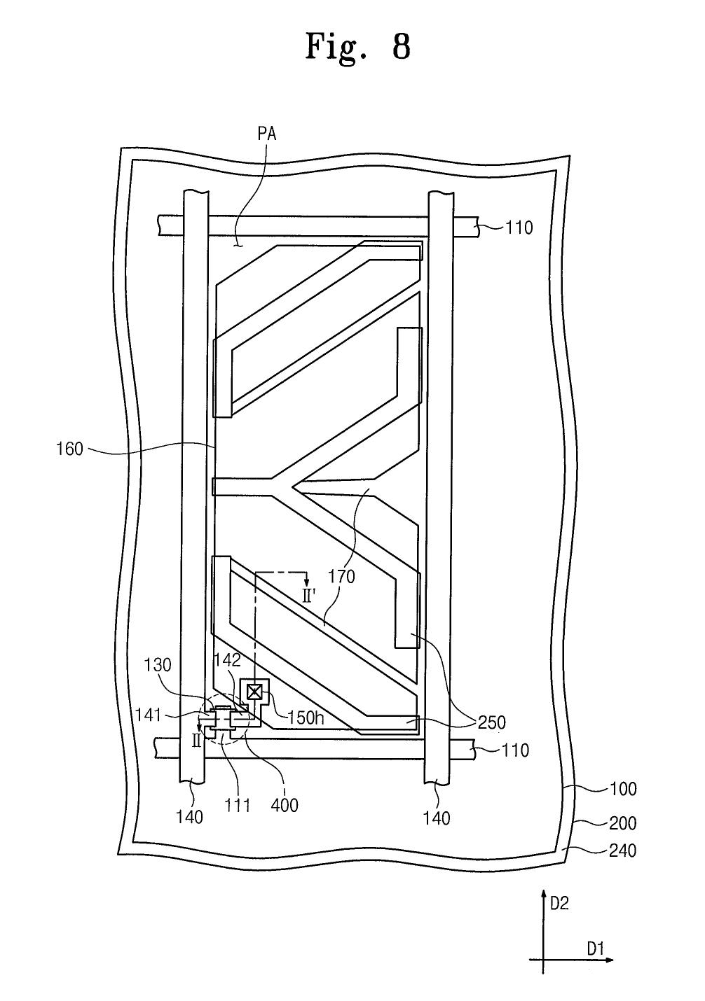

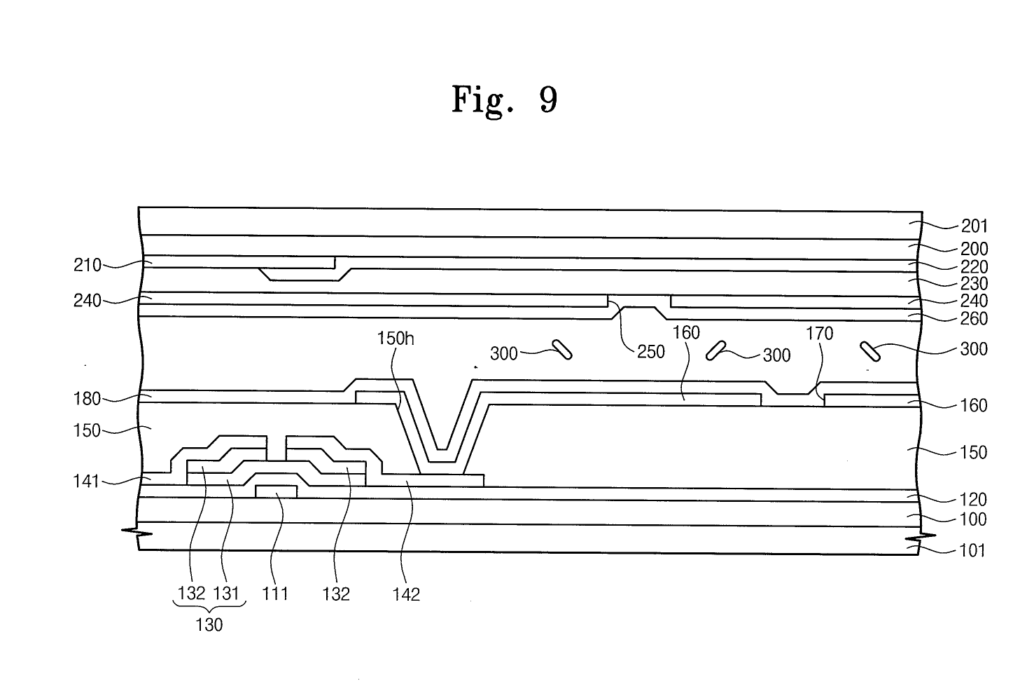

FIG. 8 is a plan view illustrating a liquid crystal display apparatus according to another exemplary embodiment of the present invention, and FIG. 9 is a cross-sectional view taken along a line II-II′ shown in FIG. 8.

Referring to FIGS. 8 and 9, the liquid crystal display apparatus includes a first substrate 100 and a second substrate 200 that faces the first substrate 100. Liquid crystals 300 are aligned between the first and second substrates 100 and 200. First and second polarizing plates 101 and 201 are attached to outer portions of the first and second substrates 100 and 200, respectively. A plurality of gate lines and data lines 110 and 140, which extend in first and second directions D₁ and D₂, respectively, are formed on the first substrate 100. The first direction D₁ is substantially perpendicular to the second direction D₂, and the gate liens 10 cross the data lines 140, thereby defining pixel areas PA on the first substrate 100. The pixel areas PA are repeatedly formed with the same structure. The detailed structure of one pixel area PA is as follows.

Pixel electrode 160 is formed on pixel area PA of the first substrate 100 and is provided with a first domain divider 170, which is a cut-out section obtained by cutting a predetermined portion of pixel electrode 160. The first domain divider 170 is tilted relative to the first and second directions D₁ and D₂, and the tilt angle of the first domain divider 170 is preferably 45°.

A thin film transistor 400 is provided in pixel area PA. The thin film transistor 400 includes a gate electrode 111 branching from the gate line 110, a source electrode 141 branching from the data line 140, and a drain electrode 142 electrically connected to pixel electrode 160 while being spaced apart from source electrode 141.

A common electrode 240 is formed on the second substrate 200. Common electrode 240 is provided with a second domain divider 250, which is a cut-out section obtained by cutting a predetermined portion of common electrode 240. The second domain divider 250 is tilted relative to the first and second directions D₁ and D₂, and the tilt part of the second domain divider 250 is substantially parallel to the tilt part of the first domain divider 170. When viewed in a plan view, the first and second domain dividers 170 and 250 are offset from each other without overlapping with each other.

During the operation of the liquid crystal display apparatus, a gate-on signal is transmitted along gate lines 110 so that the thin film transistor 400 is turned on. In addition, a data signal is transmitted along the data lines 140 so that the data voltage is applied to pixel electrode 160. At the same time, the common voltage is applied to common electrode 240, so that the electric field is formed between common electrode 240 and pixel electrode 160. Accordingly, the alignment of liquid crystals 300 is changed, so that the image is displayed on the liquid crystal display apparatus.

When the alignment of liquid crystals 300 is changed due to the electric field applied to liquid crystals 300, liquid crystals 300 are aligned in specific directions according to the direction of the first and second domain dividers 170 and 250. Since the tilt parts of the first and second domain dividers 170 and 250 are symmetrically bent about a virtual line dividing the pixel area into two equal parts, liquid crystals 300 provided in the vicinity of the tilt parts are aligned in different directions. As a result, liquid crystals 300 provided in the vicinity of the tilt parts may lose directionality, so that liquid crystals 300 are randomly aligned without being aligned in a specific direction. In this case, the operational speed of the liquid crystal display apparatus may be degraded due to the random alignment of liquid crystals 300.

In order to prevent liquid crystals 300 from being randomly aligned, the first and second domain dividers 170 and 250 may further include parts provided in substantially parallel to the first and second directions D₁ and D₂. The part formed in substantially parallel to the first direction D₁ may prevent liquid crystals 300 from being randomly aligned in the vicinity of the tilt parts. Similar to the part formed in substantially parallel to the first direction D₁, the part formed in substantially parallel to the second direction D₂ may prevent liquid crystals 300 from being randomly aligned at edge portions of pixel area PA.

As shown in FIG. 9, gate electrode 111 is formed on a predetermined portion of the first substrate 100. Gate electrode 111 is prepared in the form of a single layer or a multi-layer including a metal, such as chromium (Cr), aluminum (Al), or molybdenum (Mo), or a metal alloy. A gate insulating layer 120 including silicon nitride is formed on gate electrode 111 such that gate insulating layer 120 can cover the entire surface of the first substrate 100.

A semiconductor pattern 130 is formed on gate insulating layer 120 in such a manner that the semiconductor pattern 130 overlaps gate electrode 111. Semiconductor pattern 130 includes amorphous silicon materials and has a dual layer structure including an active pattern 131 and an ohmic contact pattern 132 formed on the active pattern 131. The active pattern 131 has an integral structure, but the ohmic contact pattern 132 is divided into two parts and doped with impurity ions.

Source electrode 141 and drain electrode 142 are formed on the semiconductor pattern 130. Source electrode 141 is spaced apart from drain electrode 142 while facing drain electrode 142. Similar to gate electrode 111, source electrode 141 and drain electrode 142 are prepared in the form of a single layer or a multi-layer including a metal, such as chromium (Cr), aluminum (Al), or molybdenum (Mo), or a metal alloy. A protective layer 150 including silicon nitride is formed on source electrode 141 and drain electrode 142. The protective layer 150 covers the entire surface of the first substrate 100. The protective layer 150 is formed with a contact hole 150h through which an upper portion of drain electrode 142 is exposed.

Pixel electrode 160 is formed on the protective layer 150. Pixel electrode 160 is inserted into the contact hole 150h such that pixel electrode 160 can be electrically connected with drain electrode 142. Pixel electrode 160 can be obtained by depositing and patterning a transparent conductive layer including indium zinc oxide or indium tin oxide. A predetermined portion of pixel electrode 160 is cut to form the first domain divider 170.

A light shielding pattern 210 is formed on the second substrate 200. Light shielding layer pattern 210 is positioned corresponding to a boundary of the pixel areas PA. An opening section is formed corresponding to the pixel areas PA. The light passes through the opening section to display the image, but the light is blocked at the boundary of the pixel areas PA by means of the light shielding pattern 210.

A color filter 220 is formed in the opening section. Color filter 220 filters light components that represent specific colors in the white light. Color filter 220 includes a red color filter, a green color filter and a blue color filter, which are regularly aligned in each pixel area PA. Images having various colors can be displayed by combining red, green and blue colors generated from the red color filter, the green color filter and the blue color filter, respectively. Color filter 220 is filled in the opening section corresponding to pixel area PA and is partially formed on the light shielding pattern 210. The light shielding pattern 210 may serve as a boundary between different colors.

An overcoat layer 230 is formed on color filter 220. Overcoat layer 230 is obtained by coating a transparent insulating layer on color filter 220 and planarizes the surface of the second substrate 200 when the surface of the second substrate 200 is irregularly formed due to color filter 220 and the light shielding pattern 210.

Common electrode 240 is formed on overcoat layer 230. Common electrode 240 includes a material identical to the material forming pixel electrode 160. Common electrode 240 is formed with the second domain divider 250, which is obtained by cutting a predetermined portion of common electrode 240. Common electrode 240 is subject to the etching process in order to form the second domain divider 250 in common electrode 240. At this time, overcoat layer 230 prevents color filter 220 from being damaged by etchant.

The first and second alignment layers 180 and 260 are formed on the pixel and common electrodes 160 and 240, respectively. When the electric field is not applied to liquid crystals 300, liquid crystals 300 are aligned vertically to the first and second substrates 100 and 200 by means of the first and second alignment layers 180 and 260. When the electric field is applied to liquid crystals 300, the alignment direction of liquid crystals 300 is changed. That is, liquid crystals 300 positioned at both sides of the first and second domain dividers 170 and 250 are aligned in opposite directions on the basis of the first and second domain dividers 170 and 250.

Pixel area PA is divided into a plurality of domains according to the alignment direction of liquid crystals 300, in which the domains compensate for the optical characteristics, thereby widening the viewing angle. In addition, liquid crystals 300 include smectic liquid crystals that form a layered structure in a specific direction. In the case of the smectic liquid crystals, liquid crystals 300 aligned in different layers are subject to relatively weak interaction, so that liquid crystals 300 may rapidly respond to the electric field prove, thereby improving the operational speed of the liquid crystal display apparatus.

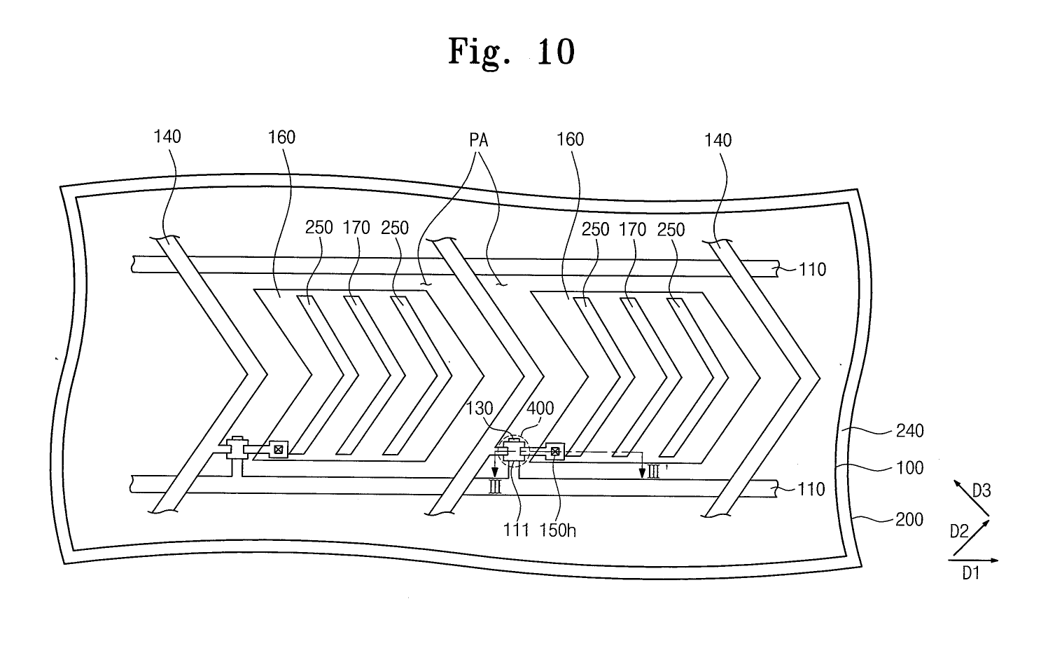

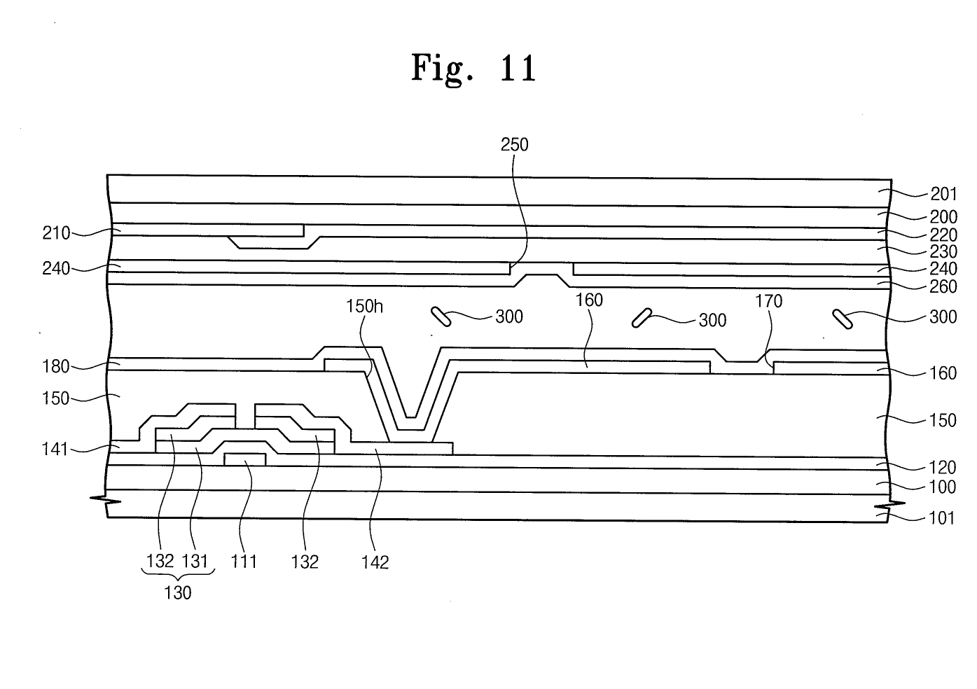

FIG. 10 is a plan view illustrating a liquid crystal display apparatus according to still another exemplary embodiment of the present invention, and FIG. 11 is a cross-sectional view taken along a line III-III′ shown in FIG. 10. In the following description, details of parts identical to those of the previous embodiment will be omitted in order to avoid redundancy.

Referring to FIGS. 10 and 11, the liquid crystal display apparatus includes a first substrate 100 and a second substrate 200 that faces the first substrate 100. Liquid crystals 300 are aligned between the first and second substrates 100 and 200. Liquid crystals 300 include smectic liquid crystals which form a layered structure in a specific direction. Gate lines 110 and data lines 140 are formed on the first substrate 100. Gate lines 110 cross the data lines 140 to define pixel areas PA on the first substrate 100. Gate lines 110 extend in the first direction D₁ and the data lines 140 consecutively extend in the second and third directions D₂ and D₃, which are bent symmetrical to each other about the first direction D₁. The second and third directions D₂ and D₃ are inclined with respect to the first direction D₁ by a predetermined angle, for example, by an angle of +45°. The pixel areas PA are repeatedly formed with the same structure. The detailed structure of one pixel area PA is as follows.

Pixel electrode 160 is formed on pixel area PA of the first substrate 100. Pixel electrode 160 has a shape corresponding to the shape of gate lines 110 and the data lines 140. In detail, pixel electrode 160 includes a pair of first surfaces parallel to the first direction D₁, a pair of second surfaces parallel to the second direction D₂, and a pair of third surfaces parallel to the third direction D₃. Pixel electrode 160 is provided with the first domain divider 170, which is substantially parallel to the second and third directions D₂ and D₃. A thin film transistor 400 is provided in pixel area PA. The thin film transistor 400 includes a gate electrode 111 connected to the gate line 110, a source electrode 141 connected to the data line 140, and a drain electrode 142 connected to pixel electrode 160.

A common electrode 240 is formed on the second substrate 200. Common electrode 240 is provided with a second domain divider 250, which is a cut-out section obtained by cutting a predetermined portion of common electrode 240. The second domain divider 250 is formed in substantially parallel to the second and third directions D₂ and D₃. When viewed in a plan view, the second and third domain dividers 170 and 250 are offset from each other without overlapping with each other.

During the operation of the liquid crystal display apparatus, the thin film transistor 400 is turned on, and a data signal is transmitted along the data lines 140 so that the data voltage is applied to pixel electrode 160. At the same time, the common voltage is applied to common electrode 240, so that the electric field is formed between common electrode 240 and pixel electrode 160. Accordingly, the alignment of liquid crystals 300 is changed, so that the image is displayed on the liquid crystal display apparatus.

At this time, the electric field may be formed between pixel electrode 160 receiving the data voltage and the data line 140 to which the data signal is being transmitted, or the electric field may be formed between adjacent pixel electrodes 160 to which different data voltages are applied. Such an electric field is called a “lateral field”, which is distinguished from the electric field formed between common electrode 240 and pixel electrode 160. The direction of the lateral field is changed depending on the shape of pixel electrode 160 or the extension direction of the data line 140.

As shown in FIG. 10, if the shape of an edge part of pixel electrode 160 is substantially parallel to the extension direction of the data line 140, liquid crystals 300 can be aligned in the same direction at the edge part of the pixel electrode due to the combination of the lateral field and the electric field formed between common electrode 240 and pixel electrode 160. In this case, liquid crystals 300 aligned in the vicinity of the edge part of pixel electrode 160 are subject to the lateral field in addition to the electric field formed between pixel electrode 160 and common electrode 240. As a result, as shown in FIG. 11, liquid crystals 300 aligned vertically to the first and second substrates 100 and 200 can be rapidly tilted with respect to the first and second substrates 100 and 200, so that the operational speed of the liquid crystal display apparatus can be improved.

The liquid crystal display apparatus according to the present invention uses smectic liquid crystals, so that the liquid crystals rapidly respond to the electric field. Thus, the operational speed of the liquid crystal display apparatus is improved. In addition, the liquid crystals are aligned in various directions in the same pixel area in such a manner that the optical characteristics can be compensated between the regions where the liquid crystals are aligned in different directions. Accordingly, the viewing angle of the liquid crystal display apparatus is widened.

Although the exemplary embodiments of the present invention have been described, it is understood that various changes and modifications will be apparent to those skilled in the art and may be made without, however, departing from the spirit and scope of the present invention.

What is claimed is:

1. A liquid crystal display apparatus comprising:
a first substrate on which a pixel area is defined;
a second substrate facing the first substrate;
smectic liquid crystals for forming a layered structure interposed between the first and second substrates;
a pixel electrode formed in the pixel area of the first substrate;
a common electrode formed on the second substrate facing the pixel electrode;
a first domain divider in the pixel area and a second domain divider facing the pixel electrode for dividing the pixel area into a plurality of domains,
wherein the layered structure of the liquid crystals is formed in a specific direction.

2. The liquid crystal display apparatus of claim 1, wherein the smectic liquid crystals have achiral and anti-ferroelectric properties.

3. The liquid crystal display apparatus of claim 2, wherein the liquid crystals are aligned substantially vertically to a predetermined direction of the layered structure.

4. The liquid crystal display apparatus of claim 2, wherein the liquid crystals are aligned while being inclined with respect to a predetermined direction of the layered structure.

5. The liquid crystal display apparatus of claim 1, further comprising a vertical alignment layer formed on the pixel electrode and the common electrode to align the liquid crystals substantially vertically to the first and second substrates.

6. The liquid crystal display apparatus of claim 5, wherein voltages are applied to the pixel electrode and the common electrode such that an electric field is applied to the liquid crystals, in which the liquid crystals represent an intermediate gray scale when the electric field is within a range of about 2 V/μm to about 3.5V/μm.

7. The liquid crystal display apparatus of claim 6, wherein the liquid crystals have a negative dielectric anisotropy.

8. The liquid crystal display apparatus of claim 1, wherein the first domain divider is a cut-out section obtained by cutting a predetermined portion of the pixel electrode, and the second domain divider is a cut-out section obtained by cutting a predetermined portion of the common electrode.

9. The liquid crystal display apparatus of claim 1, wherein the first domain divider is a cut-out section obtained by cutting a predetermined portion of the pixel electrode, and the second domain divider is a protrusion protruding from a predetermined portion of the common electrode.

10. The liquid crystal display apparatus of claim 1, further comprising a gate line and a data line, which are formed on the first substrate while crossing each other in order to define the pixel area on the first substrate.

11. The liquid crystal display apparatus of claim 10, wherein the gate line extends in a first direction and the data line extends in a second direction substantially perpendicular to the first direction.

12. The liquid crystal display apparatus of claim 11, wherein the first and second domain dividers are tilted with respect to the first and second directions.

13. The liquid crystal display apparatus of claim 12, wherein the first and second domain dividers comprise parts which are substantially parallel to at least one of the first and second directions.

14. The liquid crystal display apparatus of claim 10, wherein the gate line extends in a first direction and the data line consecutively extends in second and third directions, which are bent symmetrical to each other about the first direction.

15. The liquid crystal display apparatus of claim 10, wherein the first and second domain dividers are formed in substantially parallel to the second and third directions.
